(19) United States
(12) Patent Application Publication
(10) Pub. No.: US 2026/0128392 A1
(43) Pub. Date: May 7, 2026

(54) SOLID STATE BATTERY AND VEHICLE

(71) Applicant: HONDA MOTOR CO., LTD., Tokyo (JP)

(72) Inventors: Akihiro TAGUCHI, Saitama (JP); Takayuki YAMAMOTO, Saitama (JP); Atsushi ASAHI, Saitama (JP); Kazuya MATSUOKA, Saitama (JP); Masahiro HOKAZONO, Saitama (JP); Kenji TSUKAHARA, Saitama (JP); Fumikazu NAKAZAWA, Saitama (JP)

(21) Appl. No.: 19/372,378

(22) Filed: Oct. 29, 2025

(30) Foreign Application Priority Data
Nov. 5, 2024 (JP) 2024-193505

(51) Int. Cl. H01M 10/42; B60L 50/64; H01M 10/0585; H01M 50/105; H01M 50/211; H01M 50/249; H01M 50/264; H01M 50/289

(52) U.S. Cl. CPC H01M 10/4235; B60L 50/64; H01M 10/0585; H01M 50/105; H01M 50/211; H01M 50/249; H01M 50/264; H01M 50/289; H01M 2220/20

(57) ABSTRACT

A solid state battery includes: a plurality of cells each including a plurality of electrode bodies, the plurality of electrode bodies each including a positive electrode having a plate shape, a negative electrode having the plate shape, and a solid electrolyte layer formed between the positive electrode and the negative electrode, the plurality of electrode bodies being integrated together with a coating agent in a state in which a plurality of linear edges are aligned with each other, a position of an end surface of the coating agent being aligned in a direction perpendicular to a plane including the plurality of linear edges.

### BACKGROUND

### Technical Field

The present invention relates to a solid state battery and a vehicle.

### Related Art

In recent years, research and development on secondary batteries that contribute to energy efficiency are conducted so that more people are able to access affordable, reliable, sustainable, and advanced energy. Secondary batteries are indispensable for vehicles such as electric vehicles. As a document that discloses a technique related to a secondary battery, for example, Japanese Patent Publication No. 2016-157520 can be mentioned. The secondary battery manufactured by the manufacturing apparatus disclosed in Japanese Patent Publication No. 2016-157520 is manufactured by arranging fuel battery cells in a state of being suspended from an alignment guide rail.

### CITATION LIST

### Patent Literature

Patent Literature 1: Japanese Patent Publication No. 2016-157520

### SUMMARY

In the secondary battery manufactured by the manufacturing apparatus disclosed in Japanese Patent Publication No. 2016-157520, by the way, if the dimensions of the respective parts of a fuel battery cell vary, the edges of the respective part may not be aligned with each other. In such a case, external force is intensively applied to the edge that projects further than the other edges, and the secondary battery may be damaged. In addition, in a case where the secondary battery is mounted on a vehicle such as an electric vehicle, the secondary battery may receive the external force due to a collision with a curbstone or a collision of a stone that has bounced while the vehicle is traveling.

The present invention has been made to solve the above problems, and it is an object of the present invention to provide a solid state battery and a vehicle, by which a possibility of being damaged by external force can be reduced when mounted on a vehicle such as an electric vehicle. In addition, the present invention contributes to safety, accordingly.

In order to achieve the above object, a solid state battery according to a first aspect, includes: a plurality of cells each including a plurality of electrode bodies, the plurality of electrode bodies each including a positive electrode having a plate shape, a negative electrode having the plate shape, and a solid electrolyte layer formed between the positive electrode and the negative electrode, the plurality of electrode bodies being integrated together with a coating agent in a state in which a plurality of linear edges are aligned with each other, a position of an end surface of the coating agent being aligned in a direction perpendicular to a plane including the plurality of linear edges.

This enables the solid state battery according to the first aspect to be disposed with the end surface of the coating agent facing a direction having high frequency of receiving the external force due to a collision of a curbstone, a stone that has bounced while the vehicle is traveling, or the like. Therefore, unlike a solid state battery in which edges of the electrode bodies or the end surface of the coating agent of the cell are not aligned, the solid state battery according to the first aspect is capable of receiving external force on a surface, so that the possibility of being damaged by the external force can be reduced. In addition, the solid state battery according to the first aspect is capable of avoiding an increase in manufacturing cost due to provision of a separate member in order to ensure the strength against the external force.

In the solid state battery according to a second aspect, the coating agent and the plurality of electrode bodies may be covered with an exterior formed by lamination processing.

Accordingly, in the solid state battery according to the second aspect, it becomes possible to suppress movements of the coating agent and the plurality of electrode bodies, and to align the position of the end surface of the coating agent, so that the structure of a part where the external force is not excessively concentrated on a specific position can be more reliably maintained.

The solid state battery according to a third aspect may further include: a cushion sandwiched between the cells; an end plate sandwiching the cell and the cushion in a direction perpendicular to a broadest surface of one of the positive electrode, the negative electrode, or the solid electrolyte layer; and a bind bar sandwiching the plurality of cells in a direction parallel to the broadest surface of one of the positive electrode, the negative electrode, or the solid electrolyte layer.

Accordingly, in the solid state battery according to the third aspect, the position of the end surface of the coating agent is aligned, so that the cells can be held firmly, while the external force is prevented from being directly applied to the plurality of cells, which are disposed in a state in which the external force is not excessively concentrated on a specific position. Therefore, in the solid state battery according to the third aspect, the possibility of being damaged by the external force can be further reduced, while the external force is prevented from being directly applied to the end surface of the coating agent of each cell.

In the solid state battery according to a fourth aspect, the coating agent may be either an acrylic resin or an epoxy resin.

Accordingly, in the solid state battery according to the fourth aspect, it becomes possible to align the position of the end surface of the coating agent, and to reinforce a part where the external force is not excessively concentrated on a specific position with an acrylic resin or an epoxy resin, so that the possibility of being damaged by the external force applied to such a part can be further reduced.

In the solid state battery according to a fifth aspect, the coating agent may have a Young's modulus equal to or smaller than 40 MPa at a temperature equal to or higher than 0 degrees and equal to or lower than 40 degrees after being cured.

Accordingly, in the solid state battery according to the fifth aspect, the position of the end surface of the coating agent is aligned, and a part where the external force is not excessively concentrated on a specific position is reinforced with a material having a suitable Young's modulus, so that the possibility of being damaged by the external force applied to such a part can be further reduced.

In order to achieve the above object, a vehicle according to a sixth aspect includes the solid state battery according to one of the first aspect to the fifth aspect mounted with the end surface facing a road surface.

Accordingly, in the vehicle according to the sixth aspect, it becomes possible to reduce the possibility of being damaged by the external force due to a curbstone colliding with a lower portion of the vehicle or a stone that has bounced while the vehicle is traveling colliding with the lower portion of the vehicle.

### BRIEF DESCRIPTION OF DRAWINGS

FIG. 1 is a view illustrating an example of a solid state battery according to an embodiment; and

FIG. 2 is a view illustrating an example of arrangement of the solid state battery according to an embodiment.

### DETAILED DESCRIPTION

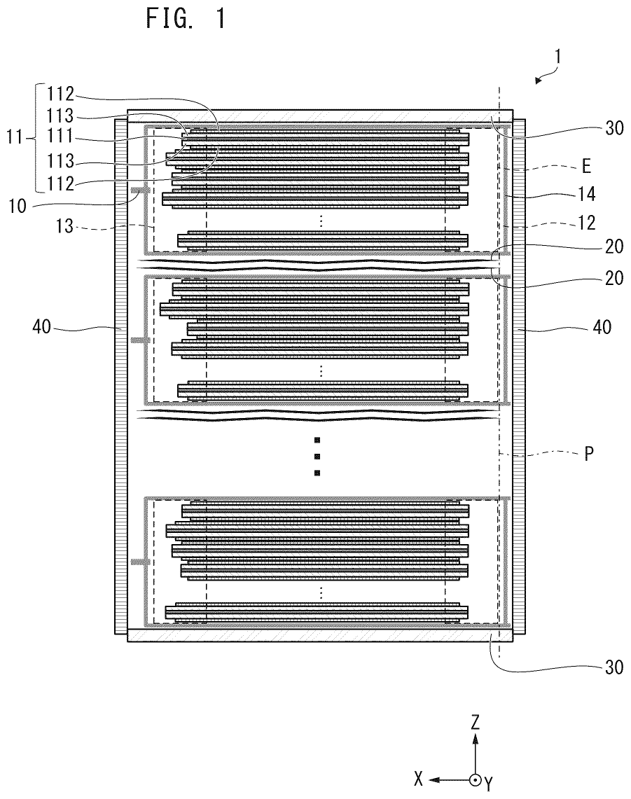

Hereinafter, embodiments of the present invention will be described with reference to the drawings. FIG. 1 is a view illustrating an example of a solid state battery according to an embodiment. The solid state battery 1 illustrated in FIG. 1 is mounted on a vehicle such as an electric vehicle in order to rotate tires of the vehicle. In addition, the vehicle on which the solid state battery 1 is mounted is not limited to four wheels, and may have two wheels, three wheels, or the like.

As illustrated in FIG. 1, the solid state battery 1 includes a cell 10, a cushion 20, an end plate 30, and a bind bar 40. Further, for example, 48 cells 10 are included in the solid state battery 1, and as illustrated in FIG. 1, each cell 10 includes a plurality of electrode bodies 11, a coating agent 12, a coating agent 13, and an exterior 14. Note that in the following description, right-handed three-dimensional orthogonal coordinates including X axis, Y axis, and Z axis illustrated in FIG. 1 are used.

As illustrated in FIG. 1, the electrode body 11 includes a positive electrode 111, a negative electrode 112, and a solid electrolyte layer 113. The positive electrode 111 is a plate-shaped electrode, and is formed in a rectangular shape. The positive electrode 111 includes plate-shaped current collecting foil, and a positive active material applied onto such current collecting foil, and receives Li ions from the solid electrolyte layer 113. The negative electrode 112 is a plate-shaped electrode disposed in parallel or substantially in parallel with the positive electrode 111 at two positions on +Z direction side and −Z direction side of the positive electrode 111, and is formed in a rectangular shape. The negative electrode 112 includes plate-shaped current collecting foil, and a negative electrode active material applied onto such current collecting foil, and emits Li ions to the solid electrolyte layer 113. The solid electrolyte layer 113 is formed between the positive electrode 111 and the negative electrode 112, which is disposed on +Z direction side of the positive electrode 111, and between the positive electrode 111 and the negative electrode 112, which is disposed on −Z direction side of the positive electrode 111.

Note that the negative electrode 112 may be disposed only on one of +Z direction side and −Z direction side of the positive electrode 111. In addition, in a case where the negative electrode 112 is disposed only on one of +Z direction side and −Z direction side of the positive electrode 111, the solid electrolyte layer 113 is formed only on the side where the negative electrode 112 is disposed.

Further, the electrode body 11 included in the cell 10 is laminated in Z direction in a state in which the positions in X direction of the linear edges parallel to Y axis on +X direction side are not aligned with each other, and the positions in X direction of the linear edges parallel to Y axis on −X direction side are aligned with each other. This is because the dimension of each electrode body 11 in X direction varies. Note that the method for laminating the electrode body 11 included in the cell 10 as illustrated in FIG. 1 is not particularly limited. In addition, for example, 27 electrode bodies 11 are included in one cell 10. Furthermore, for example, 30, 50 or 100 electrode bodies 11 may be included in one cell 10.

The coating agent 12 is fixed to the linear edges parallel to Y axis on −X direction side of each electrode body 11 and a periphery of the edges, thereby integrating the electrode bodies 11, which are included in the cell 10. In addition, in the coating agent 12 included in the cells 10, the position of an end surface E is aligned in a direction perpendicular to a plane including the edges of the plurality of electrode bodies 11, that is, in X direction. That is, the end surface E of the coating agent 12 included in the cell 10 is entirely disposed on a plane P parallel to YZ plane. The coating agent 13 is fixed to the linear edges parallel to Y axis on +X direction side of each electrode body 11 and a periphery of the edges, thereby integrating the electrode bodies 11, which are included in the cell 10. Note that the cell 10 may not necessarily include the coating agent 13.

At least one of the coating agent 12 and the coating agent 13 is preferably an acrylic resin or an epoxy resin. At least one of the coating agent 12 and the coating agent 13 preferably has a Young's modulus equal to or smaller than 40 MPa at a temperature equal to or higher than 10 degrees and equal to or lower than 25 degrees after being cured. Furthermore, at least one of the coating agent 12 and the coating agent 13 preferably has viscosity equal to or higher than 1 Pa·s and equal to or lower than 150 Pa·s before being cured.

The exterior 14 covers a surface on +X direction side of the coating agent 13, a surface on −X direction side of the coating agent 12, and surfaces on +Y direction side, surfaces on −Y direction side, surfaces on +Z direction side, and surfaces on −Z direction side of the electrode body 11, the coating agent 12, and the coating agent 13, which are included in the cell 10. The exterior 14 is formed by, for example, lamination processing, and vacuum-seals the electrode body 11, the coating agent 12, and the coating agent 13. This makes the exterior 14 apply pressure of 0.1 MPa to the electrode body 11, the coating agent 12, and the coating agent 13 so that none of the electrode body 11, the coating agent 12 and the coating agent 13 moves.

The cushion 20 is sandwiched between the cell 10 and the cell 10. The end plate 30 sandwiches the plurality of cells 10 and the plurality of cushions 20 in a direction perpendicular to the broadest surface of the positive electrode 111, the negative electrode 112, or the solid electrolyte layer 113, that is, in Z direction. Thus, the end plate 30 applies pressure of, for example, 1.5 MPa to the cell 10 and the cushion 20, which are included in the solid state battery 1. The bind bar 40 sandwiches the plurality of cells 10 in a direction parallel to the broadest surface of the positive electrode 111, the negative electrode 112, or the solid electrolyte layer 113, for example, in X direction.

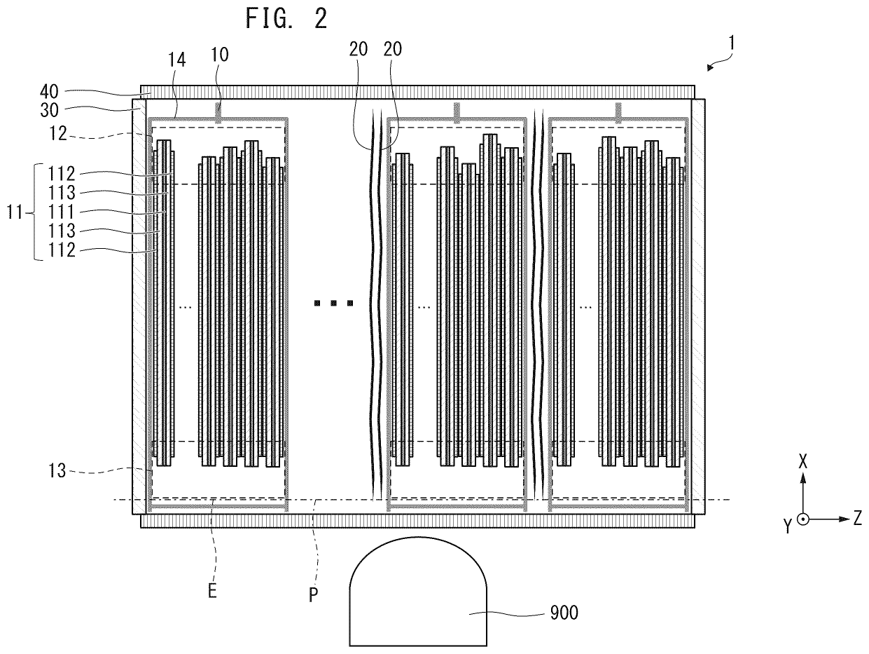

FIG. 2 is a view illustrating an example of arrangement of the solid state battery according to an embodiment. An indenter 900, which is illustrated in FIG. 2, is used for a crushing test, and simulates a curbstone that collides with the solid state battery 1, which is mounted on a vehicle such as an electric vehicle, a stone that bounces while the vehicle is traveling, or the like. When the crushing test is conducted, the indenter 900 is pressed against a surface on which the end surface E of the coating agent 12 of the solid state battery 1 is disposed, and thus external force is applied onto such a surface of the solid state battery 1.

The solid state battery 1 is mounted on a vehicle with the end surface E of each cell 10 facing in a direction with which the indenter 900 is going to collide. That is, the solid state battery 1 is mounted on a vehicle with the end surface E of each cell 10 facing a road surface. In addition, the solid state battery 1 may be included in an intelligent power unit (IPU) mounted on a vehicle.

Heretofore, the solid state battery and the vehicle according to embodiments have been described. The solid state battery 1 includes the plurality of cells 10 and the positions of the end surfaces E of the coating agent 12 are aligned with each other in X direction. Each cell 10 includes the plurality of electrode bodies 11. Each electrode body 11 includes the plate-shaped positive electrode 111, the plate-shaped negative electrode 112, and the solid electrolyte layer 113, which is formed between the positive electrode 111 and the negative electrode 112. In addition, the electrode bodies 11 included in the cell 10 are fixed to each other with the coating agent 12, in a state in which the linear edges parallel to Y direction are aligned with each other.

This enables the solid state battery 1 to be disposed with the end surface E of the coating agent 12 facing a direction having high frequency of receiving the external force due to a collision of a curbstone, a stone that has bounced while the vehicle is traveling, or the like. Therefore, unlike a solid state battery in which some electrode bodies or the end surface of the coating agent of the cell protrudes on-X direction side, the solid state battery 1 is capable of receiving external force on a surface, so that the possibility of being damaged by the external force can be reduced. In addition, the solid state battery 1 is capable of avoiding an increase in manufacturing cost due to provision of a separate member in order to ensure the strength against the external force.

Further, the coating agent 12, the coating agent 13, and the plurality of electrode bodies 11 are covered with the exterior 14, which is formed by the lamination processing.

Accordingly, in the solid state battery 1, it becomes possible to suppress movements of the coating agent 12, the coating agent 13, and the plurality of electrode bodies 11, and to align the position of the end surface E of the coating agent 12, so that the structure of a part where the external force is not excessively concentrated on a specific position can be more reliably maintained.

In addition, the solid state battery 1 includes the cushion 20, the end plate 30, and the bind bar 40. The cushion 20 is sandwiched between the cells 10. The end plate 30 sandwiches the cell 10 and the cushion 20 in a direction perpendicular to the broadest surface of the positive electrode 111, the negative electrode 112, or the solid electrolyte layer 113. The bind bar 40 sandwiches the plurality of cells in a direction parallel to the broadest surface of the positive electrode 111, the negative electrode 112, or the solid electrolyte layer 113.

Accordingly, in the solid state battery 1, the position of the end surface E of the coating agent 12 is aligned, so that the cells 10 can be held firmly, while the external force is prevented from being directly applied to the plurality of cells 10, which are disposed in a state in which the external force is not excessively concentrated on a specific position. Therefore, in the solid state battery 1, the possibility of being damaged by the external force can be further reduced, while the external force is prevented from being directly applied to the end surface E of the coating agent 12 of each cell 10.

In addition, in the solid state battery 1, at least one of the coating agents 12 is an acrylic resin or an epoxy resin.

Accordingly, in the solid state battery 1, it becomes possible to align the position of the end surface E of the coating agent 12, and to reinforce a part where the external force is not excessively concentrated on a specific position with an acrylic resin or an epoxy resin, so that the possibility of being damaged by the external force applied to such a part can be further reduced.

Further, in the solid state battery 1, the coating agent 12 has a Young's modulus equal to or smaller than 40 MPa at a temperature equal to or higher than 10 degrees and equal to or lower than 25 degrees after being cured.

Accordingly, in the solid state battery 1, the position of the end surface E of the coating agent 12 is aligned, and a part where the external force is not excessively concentrated on a specific position is reinforced with a material having a suitable Young's modulus, so that the possibility of being damaged by the external force applied to such a part can be further reduced.

In addition, in the solid state battery 1, the coating agent 12 has viscosity equal to or higher than 1 Pa·s and equal to or lower than 150 Pa·s before being cured.

Accordingly, in the solid state battery 1, the edges of the electrode bodies can be further easily aligned with each other by the coating agent 12 having suitable viscosity. Therefore, in the solid state battery 1, the accuracy of the position of the edge of each electrode body 11 can be enhanced, and the degree to which the external force is not excessively concentrated on a specific position can be enhanced.

In the vehicle according to an embodiment, the above-described solid state battery 1 is mounted with the end surface E facing the road surface.

Accordingly, in the vehicle according to an embodiment, the end surface E of the coating agent 12 faces a direction having high frequency of receiving the external force due to a collision with a curbstone, a stone that has bounced while the vehicle is traveling, or the like, so that the possibility that the solid state battery 1 is damaged by the external force can be reduced.

Heretofore, preferred embodiments of the present invention have been described. However, the present invention is not limited to the above-described embodiments. That is, the present invention includes embodiments subjected to various modifications, substitutions, design changes, and the like based on the gist of the present invention, and does not exclude these embodiments.

What is claimed is:

1. A solid state battery comprising: a plurality of cells each including a plurality of electrode bodies, the plurality of electrode bodies each including a positive electrode having a plate shape, a negative electrode having the plate shape, and a solid electrolyte layer formed between the positive electrode and the negative electrode, the plurality of electrode bodies being integrated together with a coating agent in a state in which a plurality of linear edges are aligned with each other, a position of an end surface of the coating agent being aligned in a direction perpendicular to a plane including the plurality of linear edges.

2. The solid state battery according to claim 1, wherein the coating agent and the plurality of electrode bodies are covered with an exterior formed by lamination processing.

3. The solid state battery according to claim 1, further comprising:
a cushion sandwiched between the cells;
an end plate sandwiching the cell and the cushion in a direction perpendicular to a broadest surface of one of the positive electrode, the negative electrode, or the solid electrolyte layer; and
a bind bar sandwiching the plurality of cells in a direction parallel to the broadest surface of one of the positive electrode, the negative electrode, or the solid electrolyte layer.

4. The solid state battery according to claim 1, wherein the coating agent is either an acrylic resin or an epoxy resin.

5. The solid state battery according to claim 1, wherein the coating agent has a Young's modulus equal to or smaller than 40 MPa at a temperature equal to or higher than 0 degrees and equal to or lower than 40 degrees after being cured.

6. A vehicle comprising the solid state battery according to claim 1 mounted with the end surface facing a road surface.
